(19) United States
(12) Patent Application Publication
(10) Pub. No.: US 2025/0347908 A1
(43) Pub. Date: Nov. 13, 2025

(54) SCANNING OPTICAL DEVICE AND IMAGE FORMING APPARATUS

(71) Applicant: CANON KABUSHIKI KAISHA, Tokyo (JP)

(72) Inventor: KAZUSHI INO, Shizuoka (JP)

(21) Appl. No.: 19/193,468

(22) Filed: Apr. 29, 2025

(30) Foreign Application Priority Data
May 13, 2024 (JP) 2024-077829

(51) Int. Cl. G02B 26/12; G03G 15/043

(52) U.S. Cl. CPC G02B 26/122; G02B 26/12; G03G 15/0435

(57) ABSTRACT

A scanning optical device includes an optical box accommodating a light source, a deflector and a scanning lens. The deflector includes a coaxial portion coaxially positioned with a rotational center of a polygon mirror. The optical box includes a plurality of fitting portions fitted to a coaxial portion in a different positions. Of the fitting portions, with reference to one of the fitting portions, another is disposed in a region surrounded from a bisector between an incident laser emitted toward the polygon mirror from the light source and a laser, which is reflected by the polygon mirror and reaches a starting position of writing of the scanned surface, before being incident on the scanning lens to a bisector between the incident laser and a laser, which is reflected by the polygon mirror and reaches an ending position of writing, before being incident on the scanning lens in a rotational direction.

### FIELD OF THE INVENTION AND RELATED ART

The present invention relates to a scanning optical device and an image forming apparatus. That is, the present invention relates to a scanning optical device, which is used in a device such as a laser printer, a copy machine or a facsimile, for example, which equips a function to form an image on a transfer material (recording material) such as a sheet, and an image forming apparatus including the scanning optical device.

The scanning optical device, which is used in the image forming apparatus such as a conventional laser printer, optically modulates a laser luminous flux which is emitted from a light source according to an image signal, and the optically modulated laser luminous flux is deflected and scanned by a deflector which includes a rotatable polygon mirror, for example. The deflected and scanned laser luminous flux is formed into an image on a photosensitive drum by a scanning lens such as an fθ lens and forms an electrostatic latent image thereon. Next, the electrostatic latent image on the photosensitive drum is visualized into a toner image by a developing device, the toner image is transferred to the recording material such as a recording paper, the recording material is sent to a fixing device, and by the toner on the recording material being heated and fixed, printing (print) is performed. As to the image forming apparatus, various products with different printing speeds, durability, etc. have been launched to correspond various use cases of users. For example, for a personal use, a more compact image forming apparatus is needed, and for a large scale office, fast printing speed with high durability is needed.

As to the conventional image forming apparatus, in order to correspond these various needs from the users, various image forming apparatuses have been developed corresponding to the printing speed and other specifications. In parallel with this, the scanning optical devices also have been developed separately to be optimized corresponding to the image forming apparatuses. For example, in Japanese Patent No. 6700746, a configuration of an optical box to which a plurality of the deflectors can be assembled is disclosed.

However, the conventional example have the following problems. That is, an axis of each hole in the optical box, to which different deflectors are assembled, is common, and the rotatable polygon mirror has the same number of surfaces in each deflector. Therefore, it is difficult to correspond to the rotatable polygon mirrors in which the number of surfaces are increased in order to hasten the printing speed of the image forming apparatus. Usually, upon increasing the number of surfaces of the rotatable polygon mirror, an optical system corresponding thereto becomes new and then the scanning optical device becomes new. Therefore, investing to new facilities such as manufacturing devices and molds may result, and it may cost significantly. As a result, cost of the scanning optical device and the image forming apparatus may rise.

### SUMMARY OF THE INVENTION

The present invention is conceived under such a background, and an object of the present invention is to realize a scanning optical device which corresponds to various printing speeds at a low cost by suppressing capital investment as much as possible.

According to an aspect of the present invention, there is provided (1) a scanning optical device comprising: a light source; a deflector configured to deflect a laser luminous flux emitted from the light source, the deflector including a rotatable polygon mirror configured to reflect the laser luminous flux; a scanning lens configured to focus the laser luminous flux deflected by the rotatable polygon mirror to a scanned surface; and an optical box configured to accommodate the light source, the deflector and the scanning lens, wherein the deflector includes a coaxial portion coaxially positioned with a rotational center of the rotatable polygon mirror, wherein the optical box includes a plurality of fitting portions fitted to the coaxial portion in different positions in a plane perpendicular to an axial direction of the coaxial portion, and wherein, of the plurality of the fitting portions, with reference to one of the fitting portions, another of the fitting portions is disposed in a region surrounded from a bisector between an incident laser luminous flux, which is a laser luminous flux emitted toward the rotatable polygon mirror from the light source, and a laser luminous flux, which is reflected by the rotatable polygon mirror and reaches a starting position of writing of the scanned surface, before being incident on the scanning lens to a bisector between the incident laser luminous flux and a laser luminous flux, which is reflected by the rotatable polygon mirror and reaches an ending position of writing of the scanned surface, before being incident on the scanning lens in a rotational direction of the rotatable polygon mirror.

According to an aspect of the present invention, there is provided (2) a scanning optical device comprising: a light source; a deflector configured to deflect a laser luminous flux emitted from the light source, the deflector including a rotatable polygon mirror configured to reflect the laser luminous flux; a scanning lens configured to focus the laser luminous flux deflected by the rotatable polygon mirror to a scanned surface; and an optical box configured to accommodate the light source, the deflector and the scanning lens, wherein the deflector includes a coaxial portion coaxially positioned with a rotational center of the rotatable polygon mirror, wherein the optical box includes a point symmetrical hole shape portion configured to restrict at least one direction in a plane perpendicular to an axial direction of the coaxial portion and not to restrict the other direction perpendicular to the one direction in the plane, and wherein when an intersection of a first bisector between an incident laser luminous flux which is a laser luminous flux emitted toward the rotatable polygon mirror from the light source and a laser luminous flux, which is reflected by the rotatable polygon mirror and reaches a starting position of writing of the scanned surface, before being incident on the scanning lens and a second bisector between the incident laser luminous flux and a laser luminous flux, which is reflected by the rotatable polygon mirror and reaches an ending position of writing of the scanned surface, before being incident on the scanning lens is defined as a reference, a longitudinal direction of the hole shape portion is a direction of an imaginary line connecting the intersection and a point positioned in a region from the first bisector to the second bisector in a rotational direction of the rotatable polygon mirror.

According to an aspect of the present invention, there is provided (3) an image forming apparatus of an electrophotographic type comprising: an image bearing member including the scanned surface; a scanning optical device according to (1) configured to scan the image bearing member with a laser luminous flux depending on image information; and an image forming means, after developing an electrostatic latent image formed on the image bearing member and depending on the image information, configured to transfer to a recording material and to from an image on the recording material.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus in Embodiments 1 and 2.

FIG. 2 is a perspective outline view of a scanning optical device in the Embodiments 1 and 2.

FIG. 3 is a top view when a laser luminous flux is scanned at a starting position of writing in the Embodiments 1 and 2.

FIG. 4 is a top view when the laser luminous flux is scanned at a center position in the Embodiments 1 and 2.

FIG. 5 is a top view when the laser luminous flux is scanned at an ending position of writing in the Embodiments 1 and 2.

FIG. 6, part (a) and part (b), includes outline views illustrating shapes of rotatable polygon mirrors in the Embodiments 1 and 2.

FIG. 7, part (a), part (b) and part (c), includes enlarged views illustrating relationship between phases of the rotatable polygon mirrors and the laser luminous flux in the Embodiments 1 and 2.

FIG. 8 is a cross-sectional outline view illustrating a configuration of a motor of the scanning optical device in the Embodiments 1 and 2.

FIG. 9 is a perspective outline view illustrating a configuration of an optical box and the motor of the scanning optical device in the Embodiments 1 and 2.

FIG. 10, part (a) and part (b), includes enlarged views illustrating positional relationship between a hole and a shaft of the motor in the scanning optical device in the Embodiment 1.

FIG. 11 is an enlarged outline view illustrating a configuration of the hole of the scanning optical device in the Embodiment 1.

FIG. 12 is an outline view of a configuration a hole of a scanning optical device in an Embodiment 2.

FIG. 13, part (a), part (b), part (c), part (d1), part (d2) and part (e), includes views illustrating Modified Examples of the hole in the Embodiments 1 and 2.

### DESCRIPTION OF THE EMBODIMENTS

### Embodiment 1

An image forming apparatus provided with a scanning optical device according to Embodiments of the present invention will be described. Incidentally, in the following description, first, the image forming apparatus provided with the scanning optical device according to the Embodiments of the present invention will be exemplified and described, and then, the scanning optical device in the image forming apparatus will be described. Incidentally, dimensions, material, shapes, relative arrangement, etc. of constituting components described in the Embodiments below are, unless otherwise specifically described in particular, not intended to limit the scope of the present invention only thereto.

### [Image Forming Apparatus]

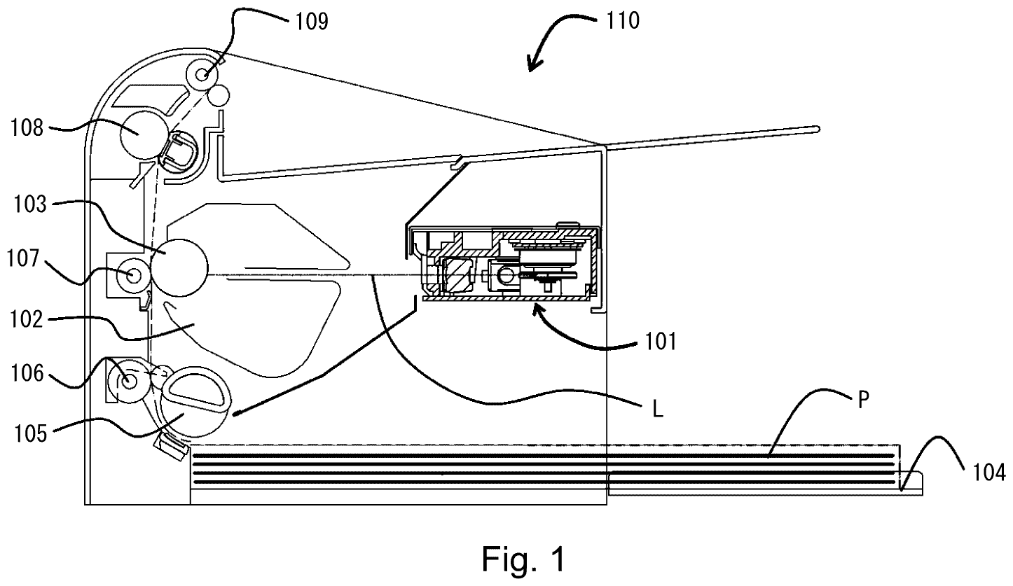

FIG. 1 is a schematic cross-sectional view illustrating an image forming apparatus of an electrophotographic type in an Embodiment 1. An image forming apparatus 110 in the Embodiment 1 is an image forming apparatus provided with a scanning optical device 101 as an exposure means, a photosensitive drum 103 as an image bearing member, and a process cartridge 102 as an image forming means. A laser luminous flux, which is emitted from the scanning optical device 101, scans the photosensitive drum 103. The process cartridge 102 performs an image formation on a recording material P such as a recording paper based on a scanned image. Here, as the image forming apparatus 110, a printer will be exemplified and described.

As illustrated in FIG. 1, the image forming apparatus (printer) 110 emits a laser luminous flux L based on an acquired image information with the scanning optical device 101, and irradiates the photosensitive drum 103 incorporated in the process cartridge 102. Then, a latent image is formed on the photosensitive drum 103, and the latent image is visualized as a toner image by toner as developer. Incidentally, the process cartridge 102 is a cartridge which includes the photosensitive drum 103 and a charging means, a developing means, etc. (not shown) as a process means which act on the photosensitive drum 103 integrally.

On the other hand, the recording material P stacked on a stacking plate 104 is fed while being separated one by one by a feeding roller 105, and then conveyed to a further downstream side by an intermediate roller 106. On the conveyed recording material P, the toner image formed on the photosensitive drum 103 is transferred by a transfer roller 107. The recording material P, on which the unfixed toner image is formed, is conveyed to the further downstream side, and the toner image is fixed to the recording material P by a fixing unit 108, which includes a heating member inside. Thereafter, the recording material P is discharged outside the apparatus by a discharging roller 109.

Incidentally, in the Embodiment 1, it is configured that the charging means and the developing means as the process means which act on the photosensitive drum 103 are integrally provided in the process cartridge 102 together with the photosensitive drum 103, however, each process means may be configured separately from the photosensitive drum 103. In addition, the image forming apparatus provided with the scanning optical device 101 to which the present invention is applied, is not limited to the image forming apparatus in FIG. 1.

### [Scanning Optical Device]

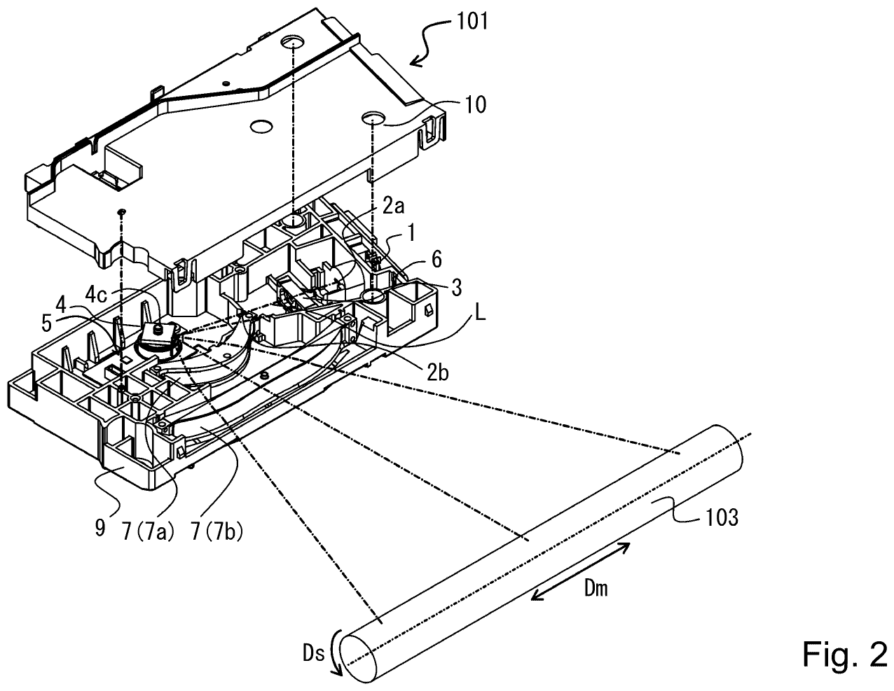

Next, the scanning optical device 101 in the image forming apparatus 110 will be described using FIG. 2. FIG. 2 is an explanatory view of the scanning optical device 101 in the Embodiment 1. The scanning optical device 101 includes a semiconductor laser unit 1, an aperture diaphragm 2a in a sub scanning direction, an incident lens 3, an aperture diaphragm 2b in a main scanning direction, a rotatable polygon mirror 4, a motor 5, a rotational axis 4c, a BD (beam detector) 6, a scanning lens 7, an optical box 9 and a lid 10. The semiconductor laser unit 1 as a light source emits the laser luminous flux. The motor 5 as a deflector rotationally drives the rotatable polygon mirror 4 integrally with the rotatable polygon mirror 4. The rotational axis 4c is a rotational axis of the rotatable polygon mirror 4. The BD 6 outputs a synchronizing signal in response that the laser luminous flux is incident thereon. The scanning lens 7 is a lens which collectively refers to a scanning lens 7a and a scanning lens 7b, and is a lens for scanning the laser luminous flux, which is deflected by the rotatable polygon mirror 4, against a scanned surface. In addition, the incident lens 3 is a compound anamorphic collimator lens in which an anamorphic collimator lens, in which a collimator lens and a cylindrical lens are integrated, and a BD lens are integrally molded. The optical box 9 accommodates the semiconductor laser unit 1, the incident lens 3, the rotatable polygon mirror 4, the motor 5 and the scanning lens 7. In addition, as shown in FIG. 2, a scanning direction of the laser luminous flux L (or a rotational axis direction of the photosensitive drum 103) is defined as the main scanning direction (Dm), and a rotational direction of the photosensitive drum 103 is defined as the sub scanning direction (Ds).

In such the configuration, the laser luminous flux L emitted from the semiconductor laser unit 1 is limited in a luminous flux width thereof in the sub scanning direction by the aperture diaphragm 2a, and is made to be an approximate collimated light or a converged light in the main scanning direction and a converged light in the sub scanning direction by the incident lens 3. Next, the laser luminous flux L passes through the aperture diaphragm 2b and the luminous flux width thereof in the main scanning direction is limited, and on a reflecting surface of the rotatable polygon mirror 4, an image having a focal line shape, which extends long in the main scanning direction, is formed. And by the rotatable polygon mirror 4 being rotated, the laser luminous flux L is deflected and scanned, and incident on the BD lens of the incident lens 3. The laser luminous flux L which has passed through the BD lens is incident on the BD 6. At this time, the BD 6 detects the laser luminous flux L and outputs the synchronizing signal. This timing is defined as a synchronization detecting timing at a starting position of writing in the main scanning direction.

Next, the laser luminous flux Lis incident on the scanning lenses 7a and 7b. The scanning lenses 7a and 7b are designed so as to focus the laser luminous flux L to form a spot on the photosensitive drum 103 and so as to keep a scanning speed of the spot at a constant speed. In order to obtain the characteristics of the scanning lenses 7a and 7b in this manner, the scanning lenses 7a and 7b are formed of an aspheric surface lens. The laser luminous flux L, which has passed through the scanning lenses 7a and 7b, is emitted from an exit aperture of the optical box 9, and an image is formed and scanned on the photosensitive drum 103.

By the rotation of the rotatable polygon mirror 4, the laser luminous flux L is deflected and scanned, and a main scanning is performed by the laser luminous flux L on the photosensitive drum 103, and in addition, by the photosensitive drum 103 being rotationally driven about an axial line of a cylinder thereof, a sub scanning is performed. In this manner, an electrostatic latent image is formed on a surface of the photosensitive drum 103.

### [Optical System of the Scanning Optical Device]

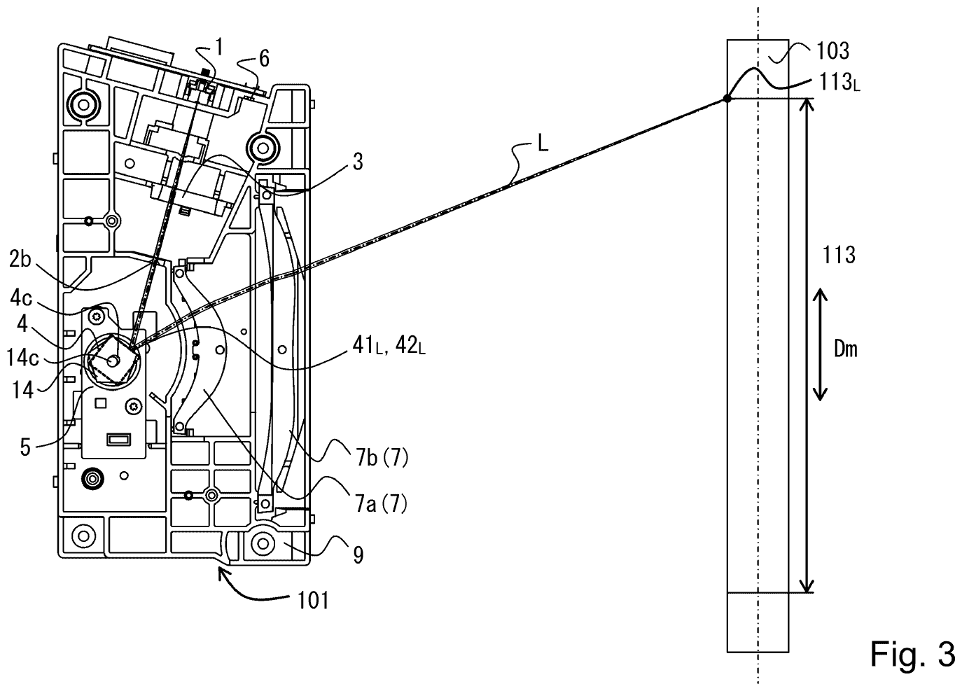

The scanning optical device 101 illustrated in FIG. 2 shows an example in which a rotatable polygon mirror with four surfaces, which has a regular square shape, is used as the rotatable polygon mirror 4. However, as shown in FIG. 3 through FIG. 7, the scanning optical device 101 is configured to be a common scanning optical device, to which not only the rotatable polygon mirror 4 with four surfaces as a first rotatable polygon mirror, but also a rotatable polygon mirror 14 with five surfaces, which has a regular pentagonal shape, as a second rotatable polygon mirror, which is different in a number of reflecting surfaces, can be assembled. With the present configuration, when the rotatable polygon mirror 14 with five surfaces are used, even if a number of rotation of the motor 5 is the same as when the rotatable polygon mirror 4 with four surfaces are used, it becomes possible to increase the scanning speed by 1.25 times. As a result, by changing from the rotatable polygon mirror 4 with four surfaces to the rotatable polygon mirror 14 with five surfaces in the scanning optical device 101, it becomes possible to realize the image forming apparatus 110 which has a faster printing speed by about 1.25 times. Incidentally, for facilitating an understanding of description, in the figures, for convenience, an outer shape of the rotatable polygon mirror 4 with four surfaces will be shown as broken lines, and an outer shape the rotatable polygon mirror 14 with five surfaces will be shown as solid lines.

In the scanning optical device 101 illustrated in FIG. 3 through FIG. 5, as described above, both when the rotatable polygon mirror 4 with four surfaces is used and when the rotatable polygon mirror 14 with five surfaces is used, the common members are used except the rotatable polygon mirrors. In other words, the semiconductor laser unit 1, the incident lens 3, the BD 6, the scanning lenses 7a and 7b, the optical box 9 and the lid 10 are all the same and assembled to the same location.

In the rotatable polygon mirror 4 with four surfaces and the rotatable polygon mirror 14 with five surfaces in the Embodiment 1, a distance from the rotational axis 4c to the reflecting surface and a distance from a rotational axis 14c to the reflecting surface are different. Therefore, in order to use both with the common members, it is configured that the rotatable polygon mirror 4 with four surfaces and the rotatable polygon mirror 14 with five surfaces can be assembled with shifting positions of the rotational axis 4c and the rotational axis 14c, respectively.

### (Starting Position of Writing)

In FIG. 3, a state of the rotatable polygon mirrors 4 and 14 when the laser luminous flux L, which reaches a starting position of writing 113_{L} on one end portion of an image guarantee area 113 of the photosensitive drum 103, is scanned is illustrated. A reflecting point 41_{L} indicates a reflecting point of the laser luminous flux L in the rotatable polygon mirror 4 with four surfaces, and a reflecting point 42_{L} indicates a reflecting point of the laser luminous flux L in the rotatable polygon mirror 14 with five surfaces. As shown in FIG. 3, a position of the reflecting point 41_{L} and a position of the reflecting point 42_{L} are approximately the same or approximately coincide. By disposing as such, it is allowed for the rotatable polygon mirrors with four surfaces and five surfaces to use the common optical system.

### (Center Position)

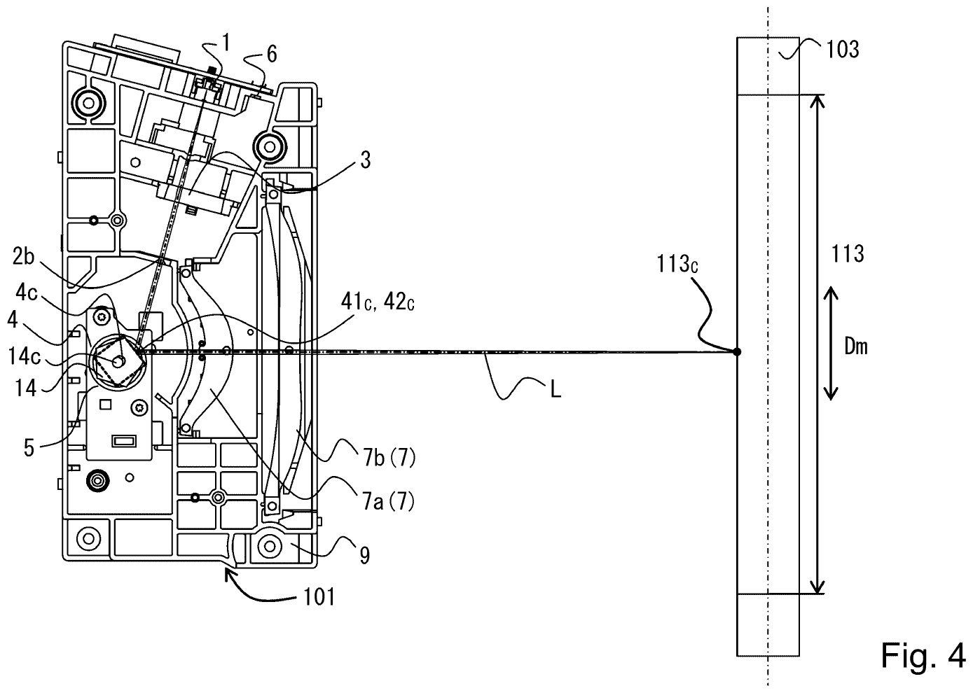

In FIG. 4, a state of the rotatable polygon mirrors 4 and 14 when the laser luminous flux L, which reaches a center position 113_{C} of the image guarantee area 113 of the photosensitive drum 103, is scanned is illustrated. The laser luminous flux L at this time is a ray which is scanned to the center position 113_{C} of the image guarantee area 113 and also a luminous flux which is scanned to optical axes in design of the scanning lenses 7a and 7b. As shown in FIG. 4, a position of a reflecting point 41c of the laser luminous flux L in the rotatable polygon mirror 4 with four surfaces and a position of a reflecting point 42_{C} of the laser luminous flux L in the rotatable polygon mirror 14 with five surfaces are also approximately the same.

### (Ending Position of Writing)

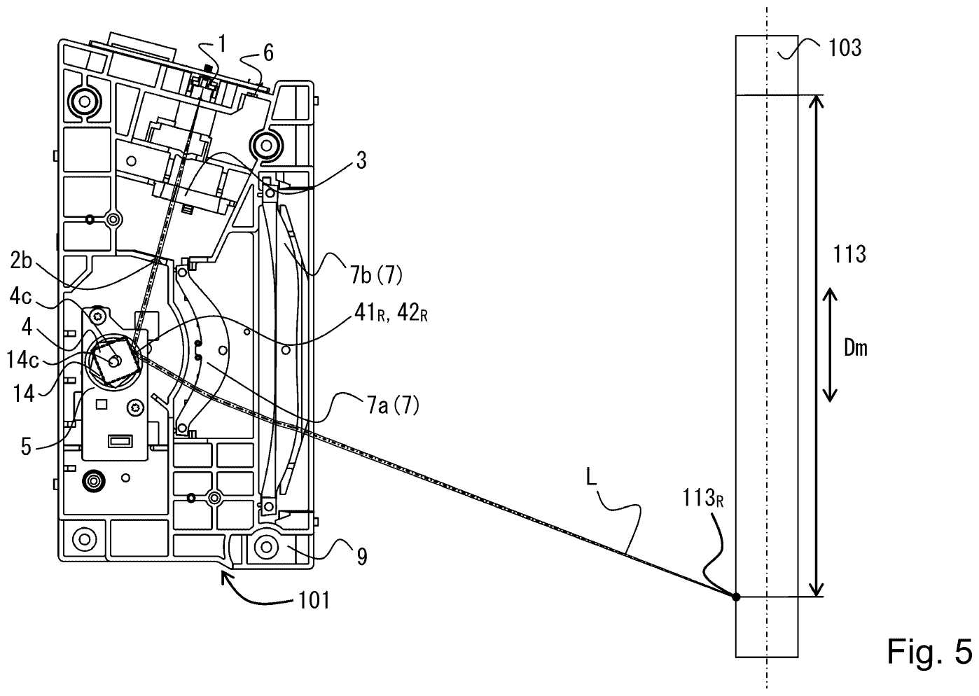

In addition, in FIG. 5, a state of the rotatable polygon mirrors 4 and 14 when the laser luminous flux L, which reaches an ending position of writing 113_{R} on the other end portion of the image guarantee area 113 of the photosensitive drum 103, which is positioned in the main scanning direction Dm, is scanned is illustrated. In this case as well, a position of a reflecting point 41_{R} in the rotatable polygon mirror 4 with four surfaces and a position of a reflecting point 42_{R} in the rotatable polygon mirror 14 with five surfaces are approximately the same. In the following description, each reflecting point 41_{L}, 41_{C} and 41_{R} of the rotatable polygon mirror 4 with four surfaces are collectively referred to as a reflecting point 41, and each reflecting point 42_{L}, 42_{C} and 42_{R} of the rotatable polygon mirror 14 with five surfaces are collectively referred to as a reflecting point 42.

[Configuration to Make the Two Reflecting Points Coincide with Each Other]

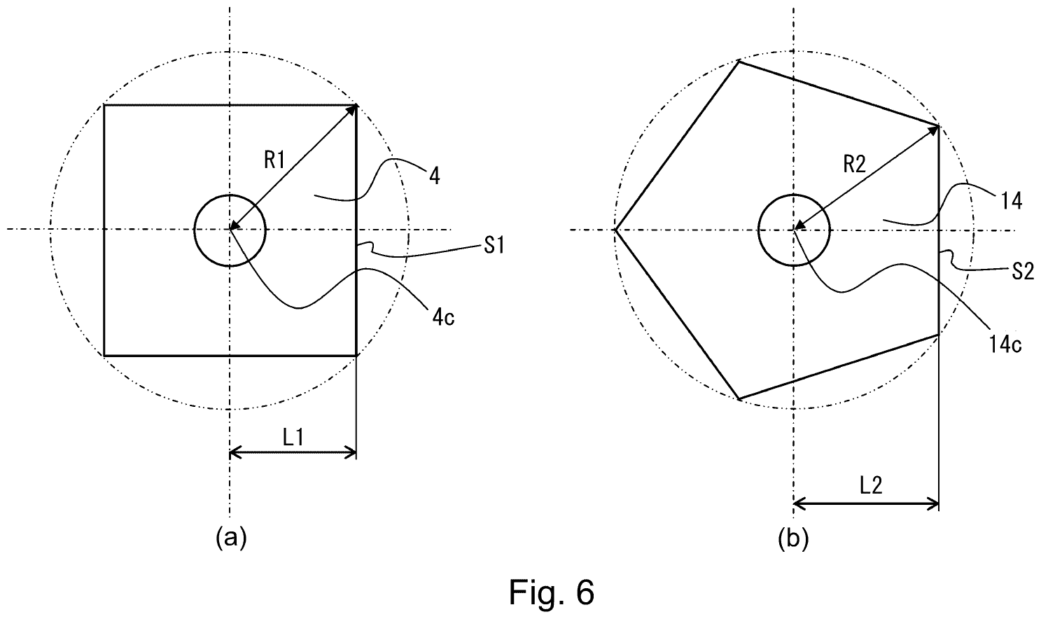

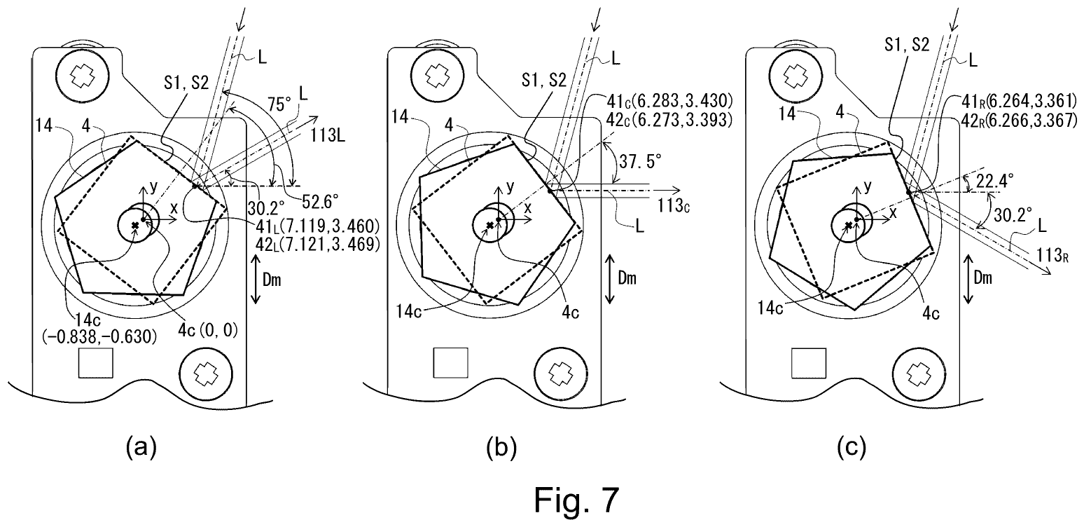

A specific configuration to make the reflecting point 41 of the rotatable polygon mirror 4 with four surfaces and the reflecting point 42 of the rotatable polygon mirror 14 with five surfaces coincide with each other will be described in detail using FIG. 6 and FIG. 7. A diameter of a circumscribed circle (chain double-dashed line) of the rotatable polygon mirror 4 with four surfaces, which is shown in part (a) of FIG. 6, is set to φ20 mm. That is, a radius R1 of the circumscribed circle of the rotatable polygon mirror 4 with four surfaces is 10 mm (R1=10 mm). Therefore, a distance L1 from the rotational axis 4c, which is at a center of the rotatable polygon mirror 4, to a reflecting surface S1 is geometrically 7.07 mm (L1=7.07 mm).

On the other hand, for the rotatable polygon mirror 14 with five surfaces as well, a diameter of a circumscribed circle (chain double-dashed line) is similarly set to @20 mm. That is, a radius R2 of the circumscribed circle of the rotatable polygon mirror 14 with five surfaces is also 10 mm (R2=10 mm). Therefore, a distance L2 from the rotational axis 14c, which is at a center of the rotatable polygon mirror 14, to a reflecting surface S2 is geometrically 8.09 mm (L2=8.09 mm). Thus, in the rotatable polygon mirror 4 with four surfaces and the rotatable polygon mirror 14 with five surfaces, the distance L1 (7.07 mm) from the center of the rotatable polygon mirror 4 (rotational axis 4c) to the reflecting surface S1 and the distance L2 (8.09 mm) from the center of the rotatable polygon mirror 14 (rotational axis 14c) to the reflecting surface S2 are different. In other words, in order to make the reflecting point 41 and the reflecting point 42 be approximately the same position, upon attempting to align the reflecting surface S1 and the reflecting surface S2, the position of the rotational axis 4c and the position of the rotational axis 14c are to be different.

As shown in FIG. 7, the main scanning direction Dm is defined as a y direction (an arrow side of a coordinate axis is +), and a direction perpendicular to the main scanning direction Dm is defined as an x direction. In this case, when the rotational axis 4c of the rotatable polygon mirror 4 with four surfaces is set as an origin (x, y)=(0, 0), the rotational axis 14c of the rotatable polygon mirror 14 with five surfaces is set at,
(x, y)=(−0.838, −0.630).

The laser luminous flux L, which is emitted from the semiconductor laser unit 1 toward the rotatable polygon mirror 4, 14, is emitted from a direction inclined 75° counterclockwise from the x axis.

Part (a) of FIG. 7 is a view illustrating states of each of the rotatable polygon mirrors 4 and 14 when the laser light flux L is emitted to the starting position of writing 113_{L} on the one end portion of the image guarantee area 113. In part (a) of FIG. 7, normal lines of the reflecting surfaces S1 and S2 of the rotatable polygon mirrors 4 and 14 are inclined 52.6° counterclockwise from the x axis. Therefore, the laser luminous flux L, which is reflected by the reflecting surfaces S1 and S2 of the rotatable polygon mirrors 4 and 14, is reflected to a direction inclined 30.2° counterclockwise from the x axis. At this time, coordinates of the reflecting point 41_{L} of the rotatable polygon mirror 4 with four surfaces is (7.119, 3.460), and coordinates of the reflecting point 42_{L} of the rotatable polygon mirror 14 with five surfaces is (7.121, 3.469). That is, a positional misalignment between the reflecting point 41_{L} and the reflecting point 42_{L} is 0.009 mm even in a larger one, and the position of the reflecting point 41_{L} and the position of the reflecting point 42_{L} are made to approximately coincide.

In addition, part (b) of FIG. 7 is a view illustrating states of each of the rotatable polygon mirrors 4 and 14 when the laser light flux Lis scanned to the center position 113_{C} of the image guarantee area 113. In part (b) of FIG. 7, the normal lines of the reflecting surfaces S1 and S2 of the rotatable polygon mirrors 4 and 14 are inclined 37.5° counterclockwise from the x axis. Therefore, the laser luminous flux L, which is reflected by the reflecting surfaces S1 and S2 of the rotatable polygon mirrors 4 and 14, is reflected toward the x direction. At this time, coordinates of the reflecting point 41_{C} of the rotatable polygon mirror 4 with four surfaces is (6.283, 3.430), and coordinates of the reflecting point 42_{C} of the rotatable polygon mirror 14 with five surfaces is (6.273, 3.393). That is, a positional misalignment between the reflecting point 41_{C} and the reflecting point 42_{C} is 0.038 mm even in a larger one, and the position of the reflecting point 41_{C} and the position of the reflecting point 42_{C} are made to approximately coincide.

Similarly, part (c) of FIG. 7 is a view illustrating states of each of the rotatable polygon mirrors 4 and 14 when the laser light flux Lis emitted to the ending position of writing 113_{R} on the other end portion of the image guarantee area 113. In part (c) of FIG. 7, the normal lines of the reflecting surfaces S1 and S2 of the rotatable polygon mirrors 4 and 14 are inclined 22.4° counterclockwise from the x axis. Therefore, the laser luminous flux L, which is reflected by the reflecting surfaces S1 and S2 of the rotatable polygon mirrors 4 and 14, is reflected to a direction inclined 30.2° clockwise from the x axis. At this time, coordinates of the reflecting point 41_{R} of the rotatable polygon mirror 4 with four surfaces is (6.264, 3.361), and coordinates of the reflecting point 42_{R} of the rotatable polygon mirror 14 with five surfaces is (6.266, 3.367). That is, a positional misalignment between the reflecting point 41_{R} and the reflecting point 42_{R} is 0.006 mm even in a larger one, and the position of the reflecting point 41_{R} and the position of the reflecting point 42_{R} are made to approximately coincide.

As described above, by shifting the rotational axis 4c of the rotatable polygon mirror 4 with four surfaces and the rotational axis 14c of the rotatable polygon mirror 14 with five surfaces, the reflecting points 41 and 42 of the rotatable polygon mirrors 4 and 14 are approximately aligned, however, strictly speaking, in the Embodiment 1, the misalignment of 0.038 mm exists at maximum. However, in the optical system in the Embodiment 1, since the positional misalignment between the positions of the reflecting points 41 and 42 is allowable up to about 0.1 mm in design, the misaligned amount of 0.038 mm is allowable.

In addition, in the configuration of the optical system of the aperture diaphragms 2a and 2b, the incident lens 3, the rotatable polygon mirrors 4 and 14, the scanning lenses 7a and 7b, etc., in the Embodiment 1, the allowable positional misalignment of the reflecting points 41 and 42 is set to about 0.1 mm. However, depending on a design of the optical system, a more positional misaligned amount of the reflecting points 41 and 42 may be allowable. Therefore, the scope of the present invention is not limited to the arrangement or the dimensions in the Embodiment 1.

### [Configuration of the Optical Box and the Rotatable Polygon Mirror of the Scanning Optical Device]

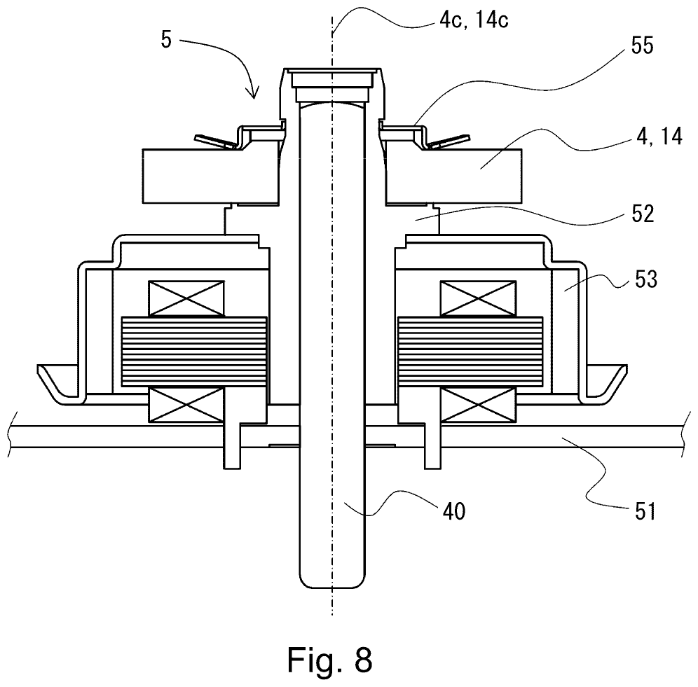

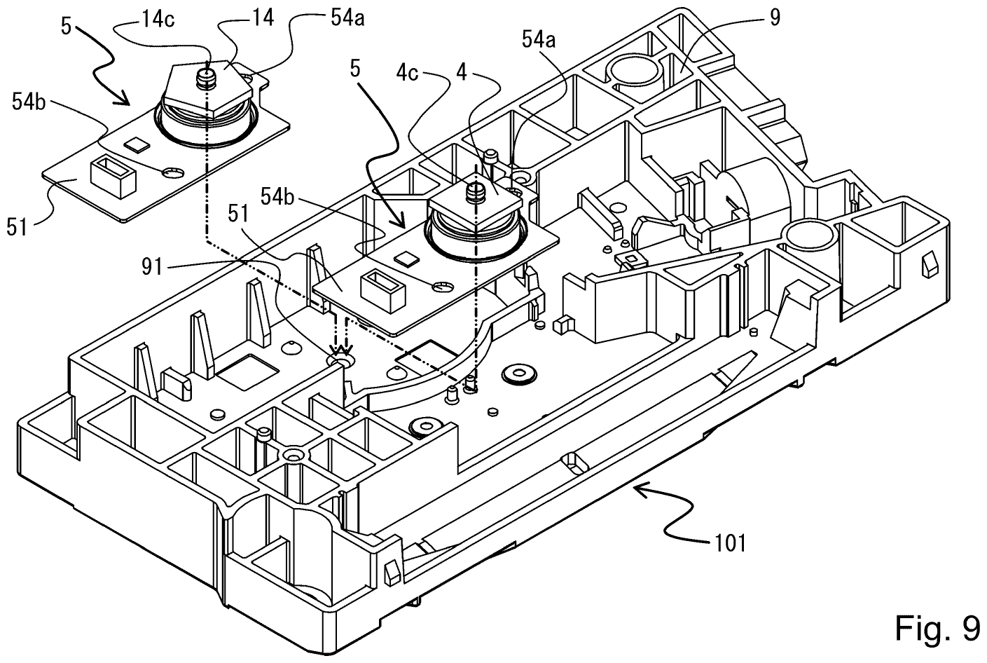

Next, a configuration related to positioning and attachment between the optical box 9 and the rotatable polygon mirrors 4 and 14 of the scanning optical device 101 will be described using FIG. 8 through FIG. 11. FIG. 8 is a cross-sectional outline view of the motor 5 of the scanning optical device 101, and FIG. 9 is an exploded outline view illustrating a state of attachment between the optical box 9 and the motor 5 of the scanning optical device 101.

In FIG. 8 and FIG. 9, the rotation axes 4c and 14c, which are rotational centers of the rotatable polygon mirrors 4 and 14, respectively, are illustrated. The motor 5 includes a shaft 40 as a coaxial portion, which is coaxially positioned with the rotation axes 4c and 14c of the rotatable polygon mirrors 4 and 14. More strictly, the shaft 40 is fixed to a substrate 51, and a sleeve 52, into which the shaft 40 is fitted via lubricating oil, is rotated with a rotor 53, the rotatable polygon mirror 4, 14, and a mirror pressing spring 55. That is, the rotational axis 4c, 14c of the rotatable polygon mirror 4, 14, and a center axis of the shaft 40 are on the same straight line. In addition, the shaft 40 is projecting to the optical box 9 side, and to the optical box 9, a hole 91 as a fitting portion, into which the shaft 40 is fitted, is provided. To the substrate 51 of the motor 5, fastening holes 54a and 54b, which is for when attaching the motor 5 onto the optical box 9, are provided.

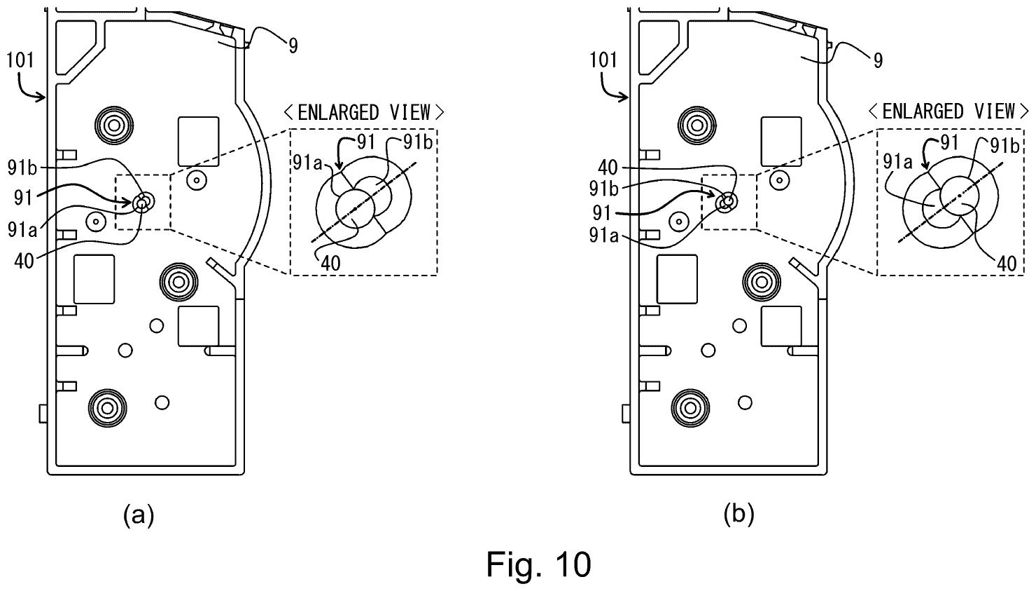

Relationship between the hole 91 of the optical box 9 and the shaft 40 will be described using FIG. 10. In part (a) of FIG. 10, positional relationship between the shaft 40 of the rotatable polygon mirror 14 with five surfaces and the hole 91 is illustrated, and in part (b) of FIG. 10, positional relationship between the shaft 40 of the rotatable polygon mirror 4 with four surfaces and the hole 91 is illustrated. On right sides thereof, enlarged views of a vicinity of the hole 91 are illustrated, respectively. The optical box 9 includes a plurality, two (round holes 91a and 91b) in the Embodiment 1, of fitting portions fitted to the shaft 40 at different positions in a plane perpendicular to an axial direction of the shaft 40.

The hole 91 has a bicircular shape in which two round holes, specifically, the round hole 91a as another fitting portion (second fitting portion) and the round hole 91b as a one fitting portion (first fitting portion) is connected. That is, the round hole 91a and the round hole 91b have a circular arc shape, and the circular arc shape of the round hole 91a and the circular arc shape of the round hole 91b are connected to form a single hole portion. Incidentally, the plane perpendicular to the axial direction of the shaft 40 corresponds to a bottom surface of the optical box 9. When the motor 5 equipped with the rotatable polygon mirror 14 with five surfaces is assembled, by the round hole 91a and the shaft 40 being fitted, the motor 5 is positioned, and fastened by screws. On the other hand, when the motor 5 equipped with the rotatable polygon mirror 4 with four surfaces is assembled, by the round hole 91b and the shaft 40 being fitted, the motor 5 is positioned, and fastened by screws.

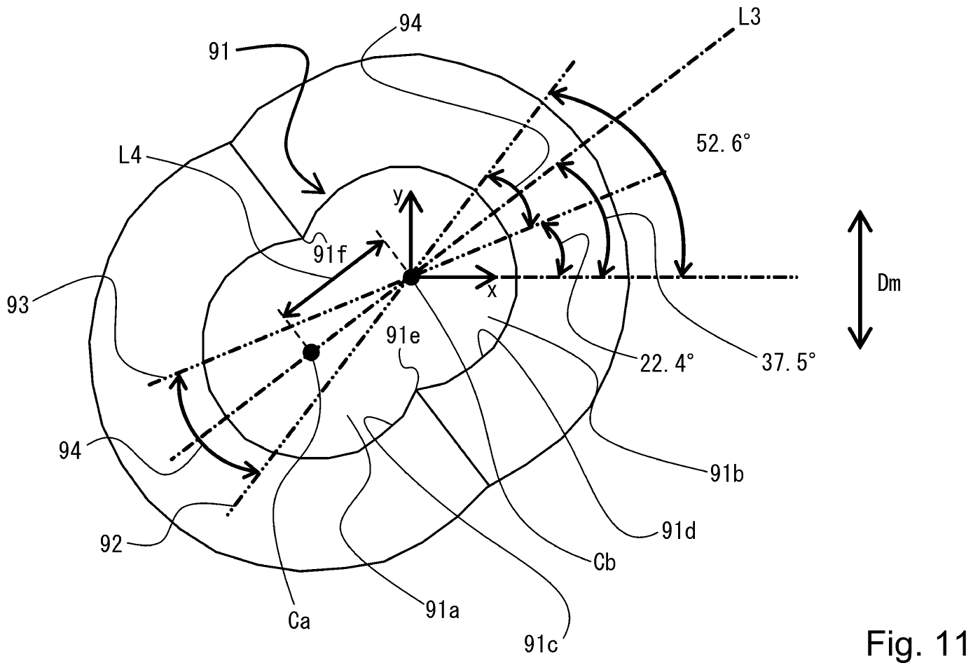

In FIG. 11, arrangement of the round hole 91a and the round hole 91b is enlarged and illustrated. The round hole 91a includes a circular arc portion 91c, and the round hole 91b includes a circular arc portion 91d. One end of the circular arc portion 91c of the round hole 91a and one end of the circular arc portion 91d of the round hole 91b are connected at a connecting portion 91e, and the other end of the circular arc portion 91c of the round hole 91a and the other end of the circular arc portion 91d of the round hole 91b are connected at a connecting portion 91f.

An imaginary line L3 (dash-dotted line) connecting a center Ca of the round hole 91a and a center Cb of the round hole 91b is disposed at an angle inclined about 37.5° to the x axis. That is, the angle of the inclination of the imaginary line L3 is the inclination of the normal direction (perpendicular direction) of the reflecting surfaces S1 and S2 in part (b) of FIG. 7. Incidentally, the center Cb of the round hole 91b is, as described in FIG. 7, the origin (0, 0) of the x-y coordinate system. A distance L4 between the center Ca of the round hole 91a and the center Cb of the round hole 91b is about 1.02 mm.

The laser luminous flux emitted from the semiconductor laser unit 1 to the rotatable polygon mirror 4, 14 is defined as an incident luminous flux (incident laser luminous flux), and the laser luminous flux upon being scanned toward the photosensitive drum 103 after being reflected by the rotatable polygon mirror 4, 14 is defined as a reflected luminous flux. Then, the angle of the imaginary line L3 connecting the center Ca of the round hole 91a and the center Cb of the round hole 91b is approximately the same as an angle of a bisector angle between the incident luminous flux and the reflected luminous flux upon being scanned toward the center position 113c of the image guarantee area 113 (see part (b) of FIG. 7).

In addition, the distance L4 between the round hole 91a and the round hole 91b is approximately the same as a difference between the distance L1 from the rotational axis 4c of the rotatable polygon mirror 4 with four surfaces to the reflecting surface S1 and the distance L2 from the rotational axis 14c of the rotatable polygon mirror 14 with five surfaces to the reflecting surface S2 (=L2−L1) (see FIG. 6). In the Embodiment 1, the difference between the distance L2 and the distance L1 is 8.09 mm-7.07 mm=1.02 mm.

An imaginary line 92 (chain double-dashed line) represents a bisector between the incident luminous flux and the reflected luminous flux upon being scanned toward the starting position of writing 113_{L}, and an imaginary line 93 represents a bisector between the incident luminous flux and the reflected luminous flux upon being scanned toward the ending position of writing 113_{R}. Specifically, as for the imaginary line 92, an angle thereof with respect to the x axis is 52.6°, which is approximately the same as the angle (52.6°) of the normal directions of the reflecting surfaces S1 and S2 described in part (a) of FIG. 7. As for the imaginary line 93, an angle thereof with respect to the x axis is 22.4°, which is approximately the same as the angle (22.4°) of the normal directions of the reflecting surfaces S1 and S2 described in part (c) of FIG. 7.

In the Embodiment 1, between the rotatable polygon mirror 4 with four surfaces and the rotatable polygon mirror 14 with five surfaces, each of the reflecting points 41 and 42 upon scanning the image guarantee area 113 of the photosensitive drum 103 are made to approximately coincide. Therefore, with reference to the center Cb of the round hole 91b, a position of the center Ca of the round hole 91a is preferably placed in a region 94 (bidirectional arrow in FIG. 11) between the imaginary line 92 and the imaginary line 93. The region 94 is a region, of regions sectioned by the imaginary line 92 and the imaginary line 93, rotated from the imaginary line 92 to the imaginary line 93 in the rotational direction of the rotatable polygon mirror 4, i.e., a region on an acute angle side in the Embodiment 1.

### MODIFIED EXAMPLES

In the Embodiment 1, it is configured as the bicircular shape in which the two round holes 91a and 91b are connected, however, as long as the distance L1 between the rotation axes 4c and 14c of the rotatable polygon mirrors 4 and 14 at two locations is sufficiently large relative to a diameter of the shaft 40, it may be configured as a shape in which two round holes are provided independently at two locations.

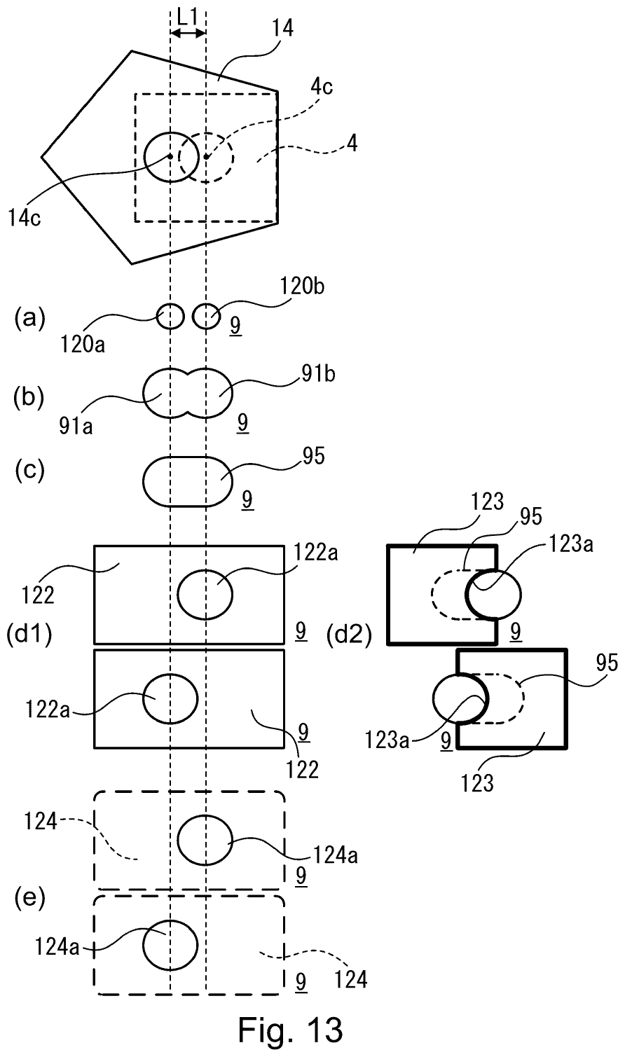

Part (a) of FIG. 13 is a view illustrating a round hole 120a and a round hole 120b, which is independent of the round hole 120a, provided to the optical box 9. The round hole 120b as the first fitting portion and the round hole 120a as the second fitting portion have independent circular shapes, respectively. Diameters of the circular shapes of the round holes 120a and 120b are smaller than a distance between a center of the circular shape of the round hole 120a and a center of the circular shape of the round hole 120b. Incidentally, above part (a) of FIG. 13, the rotatable polygon mirror 4 with four surfaces, the rotatable polygon mirror 14 with five surfaces, the rotation axes 4c and 14c, and the distance L1 are shown.

The round hole 120a is a hole into which the shaft 40 of the rotatable polygon mirror 14 with five surfaces is fitted, and the round hole 120b is a hole into which the shaft 40 of the rotatable polygon mirror 4 with four surfaces is fitted. As in part (a) of FIG. 13, in a case in which the distance L1 is larger than the diameter of the shaft 40 (in other words, the diameters of the round holes 120a and 120b), it can be configured as the two independent round holes 120a and 120b. Incidentally, part (b) of FIG. 13 shows the round holes 91a and 91b in the Embodiment 1 described above.

In the Embodiment 1, it is assumed that for the fastening of the motor 5 onto the optical box 9, screws, etc. are used. To allow the motor 5 equipped with the rotatable polygon mirror 4, 14, to be assembled at the plurality of positions, it is configured that dimensions of the fastening holes 54a and 54b provided to the substrate 51 are sufficiently large relative to a screw diameter. In the Embodiment 1, the example in which the rotatable polygon mirror 4 with four surfaces and the rotatable polygon mirror 14 with five surfaces are equipped is described, however, in terms of the number of surfaces of the rotatable polygon mirror, the scope of the present invention is not limited thereto.

In addition, a number of rotation of the rotatable polygon mirror may be different among each of the rotatable polygon mirrors. In this case, for circuit design of the motor, a winding, a control resistance, etc. may be adjusted so that rotational characteristics of the motor are optimal, or as long as the rotational characteristics thereof satisfy specifications with each of the rotatable polygon mirrors, it may be a configuration in which only the numbers of rotation are different.

In addition, in the present invention, the example when the diameters of the circumscribed circles of each rotatable polygon mirrors are the same is described, however, the diameters of the circumscribed circles may be different.

As described above, by providing a plurality of attaching positions to the optical box for each of the motors, in which the rotatable polygon mirror with different number of surfaces is equipped, it becomes possible to assemble the plurality of the rotatable polygon mirrors with different number of surfaces to the common scanning optical device. That is, in the Embodiment 1, it is the configuration in which the deflector includes the coaxial portion coaxially positioned with the rotational axis of the rotatable polygon mirror, and the optical box includes the plurality of the fitting portions fitted to the coaxial portion of the deflector at the different positions in the plane perpendicular to the axial direction of the coaxial portion of the deflector. In addition, of the round holes 91a and 91b as the plurality of the fitting portions, with reference to the round hole 91b, the position of the round hole 91a is disposed in the region 94 surrounded by the imaginary line 92 and the imaginary line 93. As a result, it becomes possible to suppress capital investment as much as possible, to realize various types of the scanning optical devices at low cost, and to provide an inexpensive image forming apparatus.

As described above, according to the Embodiment 1, it becomes possible to realize the scanning optical device corresponding to various printing speeds inexpensively by suppressing capital investment as much as possible.

### Embodiment 2

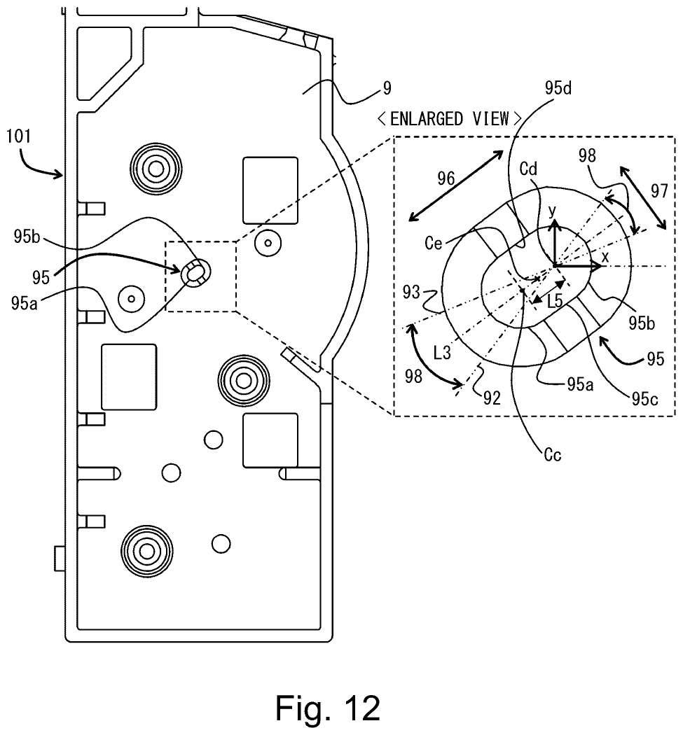

Next, a configuration of a scanning optical device 101 in an Embodiment 2 according to the present invention will be described using FIG. 12. Incidentally, for those which are configured as in the Embodiment 1, the same reference numerals are attached thereto and description thereof will be omitted. Since an overall configuration and an optical system of the scanning optical device 101 in the Embodiment 2 are the same as in the Embodiment 1, duplicating description will be omitted.

A point at which the Embodiment 2 differs from the Embodiment 1 is that a hole 95 provided to the optical box 9 is configured to be an elongated hole shape, in which two semicircular shapes of a circular arc portion 95a and a circular arc portion 95b are connected by rectilinear line portions 95c and 95d, which are tangent thereto. The optical box 9 includes the hole 95 as a point symmetrical hole shape portion which restricts at least one direction in the plane perpendicular to the axial direction of the shaft 40 (bottom surface of the optical box 9) and not restrict another direction perpendicular to the one direction in the plane. In the Embodiment 2, the one direction which is restricted is defined as a widthwise direction 97, and the other direction which is not restricted is defined as a longitudinal direction 96.

In more detail, the arc portion 95a as a second arc portion is a circular arc portion on another end side in the longitudinal direction 96, and is an arc of a semicircle centered on a point Cc (also referred to as a center Cc). The circular arc portion 95b as a first arc portion is a circular arc portion on one end portion side in the longitudinal direction 96, and is an arc of a semicircle centered on a point Cd (also referred to as a center Cd). The rectilinear line portion 95c as a first rectilinear line portion connects one end of the circular arc portion 95a and one end of the circular arc portion 95b. The rectilinear line portion 95d as a second rectilinear line portion connects the other end of the circular arc portion 95a and the other end of the circular arc portion 95b. By this, the hole 95 is formed in the elongated hole shape.

The hole 95 has a point symmetrical shape with respect to a point Ce. In the longitudinal direction 96 of the hole 95, between the circular arc portion 95a and the circular arc portion 95b of the semicircular shapes at two locations, the shaft 40 of the motor 5 can be assembled at any position. On the other hand, in the widthwise direction 97 of the hole 95, it is configured that the shaft 40 of the motor 5 can be fitted into the hole 95 to be positioned.

When the rotatable polygon mirror 14 with five surfaces is assembled to the optical box 9, the shaft 40 may be urged toward a direction of the circular arc portion 95a of the semicircular shape and abutted thereto, and the motor 5 may be fastened onto the optical box 9 by screw, etc. On the other hand, when the rotatable polygon mirror 4 with four surfaces is assembled to the optical box 9, the shaft 40 may be urged toward a direction of the circular arc portion 95b of the semicircular shape and abutted thereto, and the motor 5 may be fastened onto the optical box 9 by screw, etc. In this manner, the shaft 40 is abutted to either one side of the hole portion 95.

A distance L5 between the center Cc of the circular arc portions 95a and the center Cd of the circular arc portion 95b of the semicircular shapes at the two locations is also set to the same length as in the Embodiment 1. That is, it is set to the same length as the difference between the distance L1 from the rotational axis 4c of the rotatable polygon mirror 4 with four surfaces to the reflecting surface S1 and the distance L2 from the rotational axis 14c of the rotatable polygon mirror 14 with five surfaces to the reflecting surface S2 (1.02 mm).

The longitudinal direction 96 of the hole 95 is set to, as in the Embodiment 1, the same angle as the angle of the bisection angle between the incident luminous flux and the reflected luminous flux upon being scanned at the center position 113_{C} of the image guarantee area 113 (e.g.,) 52.6°. That is, the longitudinal direction 96 is a direction of an imaginary line L3.

Also in the Embodiment 2, between the rotatable polygon mirror 4 with four surfaces and the rotatable polygon mirror 14 with five surfaces, upon scanning the image guarantee area 113 of the photosensitive drum 103, each of the reflecting points 41 and 42 is preferably made to approximately coincide. Therefore, the longitudinal direction 96 of the hole 95 is preferably, with reference to the center Cd of the circular arc portion 95b, between an angle 98 formed by an imaginary line 92 (first bisector) and an imaginary line 93 (second bisector). In the Embodiment 2, with reference to the center Cb, which is an intersection of the imaginary line 92 and the imaginary line 93, it is configured as follows. That is, the longitudinal direction 96 of the hole 95 is in the direction of the imaginary line L3 connecting the center Cd and the center Cc, which is a point positioned in a region (the angle 98) between the imaginary line 92 and the imaginary line 93 in the rotational direction of the rotatable polygon mirror. The angle 98 between the imaginary line 92 and the imaginary line 93 means an angle from the imaginary line 92 to the imaginary line 93 in the rotational direction of the rotatable polygon mirror 4, and is on an acute angle side in FIG. 12 in the Embodiment 2 as well.

In addition, since it may also be possible to assemble the rotatable polygon mirror in any position between the longitudinal direction 96 of the hole 95, the rotatable polygon mirror can be assembled between the longitudinal direction 96 not only at the abutted positions but at a third position or a fourth position. 1. Specifically, in a state in which the shaft 40 of a predetermined rotatable polygon mirror and the circular arc portion 95a do not contact, the rotatable polygon mirror can be assembled. In addition, in a state in which the shaft 40 of the predetermined rotatable polygon mirror and the circular arc portion 95b do not contact, the rotatable polygon mirror can be assembled. Therefore, it becomes possible not only for the rotatable polygon mirror with four surfaces or the rotatable polygon mirror with five surfaces but also for a rotatable polygon mirror, which has a different number of surfaces or circumscribed circle, to be assembled to the common scanning optical device.

In addition, in the Embodiment 2, the hole 95 is configured to be the elongated hole, however, the shape of the hole may be any shape as long as the hole is long in the other direction (longitudinal direction 96) relative to the one direction (i.e., the widthwise direction 97) and has a point symmetrical shape such as a rectangle.

### Modified Example 1

Part (d1) of FIG. 13 is a view illustrating one of Modified Examples. A component 122 includes a hole 122a into which the shaft 40 of the predetermined rotatable polygon mirror is fitted. The component 122 is configured to be attachable to the optical box 9. For example, upon attaching the rotatable polygon mirror 4 with four surfaces, the component 122 is attached to the optical box 9 as illustrated in an upper view of part (d1) of FIG. 13. In addition, for example, upon attaching the rotatable polygon mirror 14 with five surfaces, the component 122 is reversed in a longitudinal direction thereof (reversing left and right thereof in the figure), and is attached to the optical box 9 as in a lower view of part (d1) of FIG. 13. By this, the positioning of the shaft 40 becomes more reliable.

Incidentally, for the optical box 9, it is sufficient that a hole, through which the shaft 40 can penetrate in both cases of the hole 122a when left and right of the component 122 are reversed, is provided thereto. Furthermore, in part (d1) of FIG. 13, one component 122 is used with reversing left and right thereof, however, it may be configured as individual components in which holes are provided corresponding to positions of the shaft 40 of each rotatable polygon mirror, respectively.

### Modified Example 2

Part (d2) of FIG. 13 is a view illustrating one of the Modified Examples. A component 123 includes a circular arc portion 123a which goes along the shaft 40 of the predetermined rotatable polygon mirror. The component 123 is configured to be attachable to the optical box 9. Here, in part (c) of FIG. 13, the hole 95 in the Embodiment 2 described above is illustrated. In the cases such as the shaft 40 of the rotatable polygon mirrors 4, 14 is abutted to the circular arc portions 95b, 95a of the hole 95 to be fixed, the component 123 can be used. For example, upon abutting the rotatable polygon mirror 4 with four surfaces to the hole 95, the component 123 is attached to the optical box 9 as illustrated in an upper view of part (d2) of FIG. 13. In addition, for example, upon abutting the rotatable polygon mirror 14 with five surfaces to the hole 95, the component 123 is reversed in a longitudinal direction thereof (reversing left and right thereof in the figure), and is attached to the optical box 9 as illustrated in a lower view of part (d2) of FIG. 13. By this, the positioning in the longitudinal direction 96 of the hole 95 becomes more reliable. Furthermore, in part (d2) of FIG. 13, the one component 123 is used with reversing left and right thereof, however, it may be configured as individual components in which depths of the circular arc portion are different corresponding to positions of the shaft 40 of each rotatable polygon mirror.

### Modified Example 3

Part (e) of FIG. 13 is a view illustrating one of the Modified Examples. A nest 124 includes a hole 124a into which the shaft 40 of the predetermined rotatable polygon mirror is fitted. The nest 124 is configured to be fitted into the optical box 9.

For example, upon attaching the rotatable polygon mirror 4 with four surfaces, the nest 124 is fitted into the optical box 9 as illustrated in an upper view of part (e) of FIG. 13. In addition, for example, upon attaching the rotatable polygon mirror 14 with five surfaces, the nest 124 is reversed in a longitudinal direction thereof (reversing left and right thereof in the figure), and is fitted into the optical box 9 as illustrated in a lower view of part (e) of FIG. 13. By this, the positioning of the shaft 40 becomes more reliable.

Incidentally, it is assumed that to the optical box 9, a hole for the nest 124 to be fitted into is provided. Furthermore, in part (e) of FIG. 13, one nest 124 is used with reversing left and right thereof, however, it may be configured as individual nests in which holes are provided corresponding to positions of the shaft 40 of each rotatable polygon mirror, respectively.

As described above, by changing the attaching position for each motor, in which the rotatable polygon mirror with different number of surfaces is equipped, it becomes possible to assemble the plurality of the rotatable polygon mirrors with different number of surfaces to the common scanning optical device. That is, in the Embodiment 2 as well, it is the configuration in which the deflector includes the coaxial portion coaxially positioned with the rotational axis of the rotatable polygon mirror, and the optical box includes the plurality of the fitting portions fitted to the coaxial portion of the deflector at different positions in the plane perpendicular to the axial direction of the coaxial portion of the deflector. In addition, by configuring the holes for attachment of each motor as the point symmetrical shape, it becomes possible to assemble the rotatable polygon mirrors with various number of surfaces and diameters, and it becomes possible to suppress capital investment for the scanning optical device further.

As described above, according to the Embodiment 2, it becomes possible to realize the scanning optical device corresponding to various printing speeds inexpensively by suppressing capital investment as much as possible.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-077829 filed on May 13, 2024, which is hereby incorporated by reference herein in its entirety.

What is claimed is:

1. A scanning optical device comprising:
a light source;
a deflector configured to deflect a laser luminous flux emitted from the light source, the deflector including a rotatable polygon mirror configured to reflect the laser luminous flux;
a scanning lens configured to focus the laser luminous flux deflected by the rotatable polygon mirror to a scanned surface; and
an optical box configured to accommodate the light source, the deflector and the scanning lens,
wherein the deflector includes a coaxial portion coaxially positioned with a rotational center of the rotatable polygon mirror,
wherein the optical box includes a plurality of fitting portions fitted to the coaxial portion at different positions in a plane perpendicular to an axial direction of the coaxial portion, and
wherein, of the plurality of the fitting portions, with reference to one of the fitting portions, another of the fitting portions is disposed in a region surrounded from a bisector between an incident laser luminous flux, which is a laser luminous flux emitted toward the rotatable polygon mirror from the light source, and a laser luminous flux, which is reflected by the rotatable polygon mirror and reaches a starting position of writing of the scanned surface, before being incident on the scanning lens to a bisector between the incident laser luminous flux and a laser luminous flux, which is reflected by the rotatable polygon mirror and reaches an ending position of writing of the scanned surface, before being incident on the scanning lens in a rotational direction of the rotatable polygon mirror.

2. The scanning optical device according to claim 1, wherein the plurality of the fitting portions are two, and
wherein when the one of the fitting portions is a first fitting portion and the another of the fitting portions is a second fitting portion, the optical box is capable of being assembled with any of both a first rotatable polygon mirror and a second rotatable polygon mirror which is different in a number of reflecting surfaces from the first rotatable polygon mirror, and
wherein the coaxial portion is fitted into the first fitting portion in a case of being coaxially positioned with the first rotatable polygon mirror and is fitted into the second fitting portion in a case of being coaxially positioned with the second rotatable polygon mirror.

3. The scanning optical device according to claim 2, wherein the first fitting portion and the second fitting portion have a circular arc shape, and
wherein one hole portion is formed by connecting the circular arc shape of the first fitting portion and the circular arc shape of the second fitting portion.

4. The scanning optical device according to claim 2, wherein the first fitting portion and the second fitting portion have a circular shape, and
wherein a diameter of the circular shape of the first fitting portion and the second fitting portion is smaller than a distance between a center of the circular shape of the first fitting portion and a center of the circular shape of the second fitting portion.

5. A scanning optical device comprising:
a light source;
a deflector configured to deflect a laser luminous flux emitted from the light source, the deflector including a rotatable polygon mirror configured to reflect the laser luminous flux;
a scanning lens configured to focus the laser luminous flux deflected by the rotatable polygon mirror to a scanned surface; and
an optical box configured to accommodate the light source, the deflector and the scanning lens,
wherein the deflector includes a coaxial portion coaxially positioned with a rotational center of the rotatable polygon mirror,
wherein the optical box includes a point symmetrical hole shape portion configured to restrict at least one direction in a plane perpendicular to an axial direction of the coaxial portion and not to restrict the other direction perpendicular to the one direction in the plane, and
wherein when an intersection of a first bisector between an incident laser luminous flux which is a laser luminous flux emitted toward the rotatable polygon mirror from the light source and a laser luminous flux, which is reflected by the rotatable polygon mirror and reaches a starting position of writing of the scanned surface, before being incident on the scanning lens and a second bisector between the incident laser luminous flux and a laser luminous flux, which is reflected by the rotatable polygon mirror and reaches an ending position of writing of the scanned surface, before being incident on the scanning lens is defined as a reference, a longitudinal direction of the hole shape portion is a direction of an imaginary line connecting the intersection and a point positioned in a region from the first bisector to the second bisector in a rotational direction of the rotatable polygon mirror.

6. The scanning optical device according to claim 5, wherein the coaxial portion is assembled by being abutted to one side of the hole shape portion in the longitudinal direction.

7. The scanning optical device according to claim 6, wherein when the other direction is the longitudinal direction, the hole shape portion includes a first circular arc portion on one end side in the longitudinal direction, a second circular arc portion on the other end side in the longitudinal direction, a first rectilinear line portion connecting the first circular arc portion and the second circular arc portion on one end side in the one direction, and a second rectilinear line portion connecting the first circular arc portion and the second circular arc portion on the other end side in the one direction, and
wherein the optical box is capable of being assembled with any of both a first rotatable polygon mirror and a second rotatable polygon mirror which is different in a number of reflecting surfaces from the first rotatable polygon mirror, and
wherein the coaxial portion is fitted into the first circular arc portion in a case of being coaxially positioned with the first rotatable polygon mirror and is fitted into the second circular arc portion in a case of being coaxially positioned with the second rotatable polygon mirror.

8. An image forming apparatus of an electrophotographic type comprising:
an image bearing member including the scanned surface;
a scanning optical device according to claim 1 configured to scan the image bearing member with a laser luminous flux depending on image information; and
an image forming means, after developing an electrostatic latent image formed on the image bearing member and depending on the image information, configured to transfer to a recording material and to form an image on the recording material.
